(19) United States
(12) Patent Application Publication
(10) Pub. No.: US 2019/0174960 A1
(43) Pub. Date: Jun. 13, 2019

(54) ELECTRIC MOTOR-DRIVEN FOOD PROCESSOR

(71) Applicant: Vorwerk & Co. Interholding GmbH, Wuppertal (DE)

(72) Inventors: Peter HANNEMANN, Wuppertal (DE); Christiane STACH, Radevormwald (DE)

(73) Assignee: Vorwerk & Co. Interholding GmbH, Wuppertal (DE)

(21) Appl. No.: 16/309,210

(22) PCT Filed: Jun. 2, 2017
(86) PCT No.: PCT/EP2017/063507

§ 371 Date: Dec. 12, 2018

(30) Foreign Application Priority Data
Jun. 13, 2016 (DE) 10 2016 110 827.8

(51) Int. Cl. A47J 43/046; A47J 43/07; A47J 43/08

(52) U.S. Cl. CPC A47J 43/046; A47J 43/085; A47J 43/0716

(57) ABSTRACT

An electric motor-driven food processor has a base device, which has an electric motor, and a preparation vessel that can be inserted into the base device. A vessel bottom of the preparation vessel has a bottom opening, which can be closed in a fluid-tight manner by a stirring unit, that can be brought into engagement in a coupling device that can be rotated by means of the electric motor. The coupling device has a sealing element, which is connected to the coupling device in a rotationally fixed manner and which is designed to act against a corresponding immovable housing partial region of the base device, in a fluid-tight manner, while following gravity and to release the operative connection above the limit rotational speed because of a rotational-speed-dependent centrifugal force effect.

### TECHNICAL FIELD

The invention pertains to an electric motor-driven food processor with a base device that has an electric motor and with a preparation vessel that can be inserted into the base device, wherein a vessel bottom of the preparation vessel has a bottom opening that can be closed in a fluid-tight manner by means of a stirring unit, and wherein said stirring unit can be engaged into a coupling device, which can be rotated by means of the electric motor, through the bottom opening.

### PRIOR ART

Electric motor-driven food processors with a base device that has an electric motor and with a preparation vessel that can be inserted into the base device are sufficiently known from the prior art. The preparation vessel may be realized, e.g., in the form of a stirring vessel, into which the stirring unit projects through the vessel bottom. The stirring unit may be realized, e.g., in the form of a blade set with a plurality of blades in order to chop and/or stir preparation material arranged in the preparation vessel. Furthermore, the stirring unit may alternatively or additionally also carry a milk frother, e.g. for frothing milk or whipping cream.

The stirring unit closes the bottom opening of the preparation vessel in a fluid-tight manner such that preparation material contained in the preparation vessel cannot flow into the coupling device and/or the base device through the bottom opening and cause damages in said devices. However, preparation material escapes through the bottom opening if a user of the food processor forgets to install the stirring unit prior to filling the preparation vessel.

### SUMMARY OF THE INVENTION

Based on the above-described prior art, the invention aims to prevent preparation material from reaching the base device and/or the coupling device if the user forgot to install the stirring unit in the bottom opening prior to filling the preparation vessel.

In order to attain the above-defined objective, the invention initially proposes that the coupling device comprises a sealing element, which is connected to the coupling device in a rotationally fixed manner and designed for acting against a corresponding immovable partial housing region of the base device in a fluid-tight manner, particularly following gravity, at a rotational speed of the coupling device below a defined rotational speed limit, as well as for releasing the functional connection due to a rotational speed-dependent centrifugal force effect at a rotational speed above the rotational speed limit.

According to the invention, the food processor is equipped with a sealing element that is assigned to the coupling device and can be transferred from a contacting state, i.e. a state in which it rests against the partial housing region of the base device, into a non-contacting state, i.e. a state in which it is lifted off the partial housing region, in dependence on a rotational speed of the coupling device. This is based on the notion that potentially inadvertent filling of the preparation vessel without the prior installation of the stirring unit in the bottom opening of the preparation vessel takes place while the coupling device is at a standstill, i.e. while the stirring unit is still deactivated. In this case, the sealing element acts against the corresponding partial housing region of the base device and seals this base device against preparation material flowing out of the preparation vessel. The user then has the opportunity to notice his oversight and to subsequently install the stirring unit in the preparation vessel without damaging the electric motor-driven food processor.

In comparison with a sealing element that permanently acts against the corresponding partial housing region, the inventive sealing element, which acts in a rotational speed-dependent manner, has the advantage that the sealing effect, i.e. the contact of the sealing element with the partial housing region of the base device, is suspended at rotational speeds of the coupling device above the defined rotational speed limit such that wear of the sealing element, which increasingly occurs at higher rotational speeds, is prevented. In comparison with permanently non-contacting seals, the inventive solution has the advantage that a high sealing effect is achieved below the defined rotational speed limit.

The sealing element rests against the corresponding partial housing region of the base device below the defined rotational speed limit. In a particularly simple instance, this can be achieved in that the flexible sealing element rests on the partial housing region in a normal orientation of the food processor during its operative state, i.e. in a vertical, upright orientation of the food processor, such that the sealing element presses against the partial housing region following gravity. To this end, the partial housing region and the sealing element have at least one overlapping region referred to a vertical plane. However, it is not necessary that the sealing element rests on the partial housing region with its entire surface.

It would alternatively also be conceivable that the partial housing region and the sealing element do not have an overlap in the same vertical plane, but rather lie adjacent to one another, e.g. referred to a horizontal direction, wherein the flexible sealing element acts against the partial housing region, e.g., under the influence of a spring force. In this case, the spring force advantageously acts in a horizontal direction. For example, a leaf spring, coil spring or the like, the restoring force of which acts in the direction of the partial housing region, may be assigned to the sealing element for this purpose. The sealing element itself may be realized flexibly and pressed against the partial housing region due to deformation and/or movable, e.g. similar to a flap. A design of the sealing element with an integral hinge is also particularly suitable.

The defined rotational speed limit, starting at which the contact between the sealing element and the corresponding partial housing region should be suspended, is among other things dependent on the mass of the sealing element, the spatial orientation of the sealing element relative to the partial housing region and, if applicable, the force of a spring element that counteracts a centrifugal force acting upon the sealing element. In order to suspend the contacting connection between the sealing element and the partial housing region, i.e. in order to move the sealing element away from the partial housing region, the centrifugal force acting upon the sealing element due to the rotation of the coupling device must suffice for overcoming the gravitational force acting upon the sealing element and, if applicable, the restoring force of the spring element. As soon as the centrifugal force exceeds the opposing forces, the sealing element is displaced away from the corresponding partial housing region, e.g. due to the change of an adjustment angle, such that a clearance is formed between the sealing element and the partial housing region.

It is proposed that the defined rotational speed limit lies between 50 rpm and 200 rpm. Up to this rotational speed limit, the sealing element still rests against the corresponding partial housing region and acts as a contact seal. In case a user of the food processor fails to notice that he forgot to install the stirring unit while the coupling device is still at a standstill, the sealing element therefore also seals up to a rotational speed that deviates from the standstill of the coupling device and in this case advantageously amounts, e.g., to 200 rpm. For example, this rotational speed of the coupling device may be sufficient for stirring a preparation material. The user of the food processor will usually notice his oversight no later than during a stirring process because the noises, which are normally generated during such a stirring process, do not occur when the stirring unit has not been installed. The sealing effect of the sealing element on the partial housing region therefore remains intact up to the defined rotational speed limit such that the user still has the opportunity to subsequently install the stirring unit in the preparation vessel before the food processor is damaged. The rotational speed limit can basically also be defined higher, e.g. at 500 rpm, 1000 rpm or higher. In this respect, a person skilled in the art has to ponder how far the continued sealing effect of the sealing element at higher rotational speeds outweighs the disadvantages of potentially increased wear on the sealing element or the partial housing region, respectively. This ultimately also depends on the materials of the sealing element and the partial housing region.

It is proposed that the sealing element is a flexible sealing lip that surrounds the coupling device in the circumferential direction. For example, the sealing element may be arranged around the coupling device in a ring-shaped manner such that it uniformly seals the coupling device relative to the partial housing region in all possible radial directions. The flexible design of the sealing element is particularly advantageous because the sealing element itself provides a certain mobility in this case and no additional hinges or the like are required for displacing a partial region of the sealing element. The centrifugal force generated due to the rotation of the coupling device causes the flexible sealing element to be deformed, particularly such that a free radial end region of the sealing element is lifted off the partial housing region against the gravitational force and the contacting connection is thereby suspended. In this case, the sealing element may be made of flexible materials such as caoutchouc, rubber, silicone, polyethylene, polypropylene or similar flexible materials.

The sealing element is preferably glued and/or clamped on the coupling device. However, it would also be conceivable to realize the coupling device and the sealing element in one piece, e.g. in the form of a 2-component injection molded part.

It is proposed that the sealing element comprises a material with a heat resistance to temperatures greater than 100° C., preferably a heat resistance to temperatures greater than 150° C. The sealing element preferably comprises PTFE, silicone rubber, ethylene-propylene terpolymer (APTK), viton, butyl or Teflon. Due to the contacting connection of the sealing element with the corresponding partial housing region of the base device, the occurring friction causes heating of the sealing element below the defined rotational speed limit. In order to prevent damages to the sealing element, e.g. in the form of excessive abrasion, a deformation or the like, it is therefore preferred to use a heat-resistant material that can withstand the occurring temperatures of 100° C., particularly 150° C. or higher, without being damaged. The aforementioned materials are particularly suitable for this purpose.

It is furthermore proposed that the sealing element has a material thickness of 0.5 mm to 2 mm. Depending on the type of material of the sealing element, its material thickness should ensure that the sealing element has on the one hand such a weight that a fluid-tight seal with the partial housing region is produced, but is on the other hand still so light and flexible that the sealing element can be respectively lifted off or spaced apart from the partial housing region due to the centrifugal force. With respect to the aforementioned preferred materials, a material thickness of 0.5 mm to 2 mm proved particularly advantageous in practical applications.

It is furthermore proposed that the partial housing region of the base device, which corresponds to the sealing element, has a convex running surface for the sealing element. An enhanced sealing effect between the sealing element and the partial housing region is achieved due to the convex surface curvature of the running surface. In this case, the running surface may either be entirely realized in a convex manner or only comprise a partial convex region in the form of a strip or ring. Alternatively, the running surface provided on the partial housing region may also be realized plane and the sealing element may have a convexly designed contact region.

It is furthermore proposed that a radial clearance between the coupling device and the corresponding partial housing region of the base device in a contact plane of the partial housing region and the sealing element perpendicular to a rotational axis of the coupling device lies between 2 mm and 10 mm and/or that a radial length of the sealing element referred to a vertical projection of the sealing element contacting the partial housing region lies between 4 mm and 12 mm. The free space between the coupling device and the partial housing region should basically be as small as possible, in this case preferably between 2 mm and 10 mm, such that a minimal radial clearance has to be bridged by means of the sealing element and the sealing element can be realized correspondingly short. This respectively reduces or eliminates the risk that preparation material, which escapes from the preparation vessel and potentially lies on the sealing element, deforms the sealing element in such a way that a gap, through which preparation material can enter the base device, is formed between the sealing element and the corresponding partial housing region of the base device. The sealing element should be at least so long that it can completely cover the gap formed between the coupling device and the partial housing region. It is particularly proposed that the length of the sealing element is greater than the clearance between a contact point of the sealing element on the corresponding partial housing region and the partial region of the coupling device lying in the contact plane by about 5 percent to 30 percent referred to the contact plane between the partial housing region and the sealing element. The sealing element itself does not have to be realized plane over its entire length, but rather may also be curved referred to a longitudinal section through the preparation vessel or the stirring unit, respectively.

Furthermore, the sealing element may also be arranged on the coupling device in such a way that this sealing element is not oriented horizontally, i.e. perpendicular to the rotational axis of the stirring unit, at a rotational speed of the coupling device below the rotational speed limit, but rather inclined, i.e. points downward, referred to a direction from the coupling device to the partial housing region. If the sealing element projects in this position beyond the contact surface on the partial housing region referred to the contact plane, preferably is even curved around this partial region, a sealing effect can be achieved in the axial direction, as well as in the radial direction, referred to the rotational axis. When the defined rotational speed limit is exceeded, the sealing element is lifted off the corresponding partial housing region such that the vertical projection of the sealing element projects all the more over the clearance between the coupling device and the corresponding partial housing region in the contact plane. In this way, potential dripping of preparation material from the sealing element into the base device between the coupling device and the partial housing region is additionally prevented.

According to an alternative embodiment, an electric motor-driven food processor with a base device that has an electric motor and with a preparation vessel that can be inserted into the base device is likewise proposed, wherein a vessel bottom of the preparation vessel has a bottom opening that can be closed in a fluid-tight manner by means of a stirring unit, wherein said stirring unit can be engaged into a coupling device, which can be rotated by means of the electric motor, through the bottom opening, and wherein an immovable partial housing region of the base device lying adjacent to the coupling device comprises a flexible sealing element, particularly a foam body, which is provided with a fluid-tight surface layer, particularly a Teflon film, on the side acting against the coupling device.

According to this embodiment, a food processor is realized with a sealing element that produces a seal relative to a partial housing region of the base device independently of a rotational speed of the coupling device. The sealing element is realized flexibly, preferably in the form of a foam body, and acts against the partial housing region in a spring-elastic manner. In order to also achieve an optimal sealing effect at higher rotational speeds of the coupling device, the sealing element is coated with a fluid-tight surface layer, preferably of an abrasion-resistant and heat-resistant material such as Teflon. In this case, the sealing element is assigned to the immovable partial housing region of the base device while the coupling device contacting the sealing element rotates. At least a partial region of the coupling device is preferably realized in the form of a metal ring, on which the sealing element rests. The flexible sealing element preferably has spring elasticity, e.g. in the form of a foam body or rubber body, such that the sealing element is pressed against the coupling device. The spring elasticity furthermore allows an axial compensation for play and an axial mobility relative to the coupling device. In addition, a radial tolerance compensation is achieved due to the free placement of the coupling device on the sealing element. For example, the fluid-tight surface layer, e.g. in the form of the proposed Teflon film, may be glued on the sealing element.

It is ultimately proposed that the coupling device comprises a convex running surface for the sealing element, particularly a projection pointing in the axial direction, on the side acting against the sealing element and/or that the sealing element comprises a convex running surface for the coupling device, particularly a projection pointing in the axial direction, on the side acting against the coupling device. In this way, an optimal sealing effect between the coupling device and the sealing element is achieved. The convex running surface of the sealing element or the coupling device may either extend over the entire contact surface between the coupling device and the sealing element or only over part thereof, e.g. in the form of a projection pointing in the axial direction. This projection may be realized, e.g., in the form of a ring along a likewise ring-shaped surface of the sealing element or the coupling device, respectively.

### BRIEF DESCRIPTION OF THE DRAWINGS

The invention is described in greater detail below with reference to exemplary embodiments. In the drawings:

FIG. 1 shows an inventive food processor in the form of a perspective view,

FIG. 2 shows the food processor according to FIG. 1 in the form of a top view,

FIG. 3 shows a longitudinal section through the food processor including an enlarged detail in the region of a coupling device for a stirring unit,

FIG. 4 shows an enlarged partial region of the food processor between the coupling device and a corresponding partial housing region of a base device with a sealing element in a contact position,

FIG. 5 shows the partial region according to FIG. 4 with the sealing element in a non-contact position,

FIG. 6 shows a second design variation of a partial region with a sealing element in a contact position,

FIG. 7 shows the partial region according to FIG. 6 with the sealing element in a non-contact position, and

FIG. 8 shows a partial region of the food processor in the region of a stirring unit with a sealing element and a coupling device according to another design variation.

### DESCRIPTION OF THE EMBODIMENTS

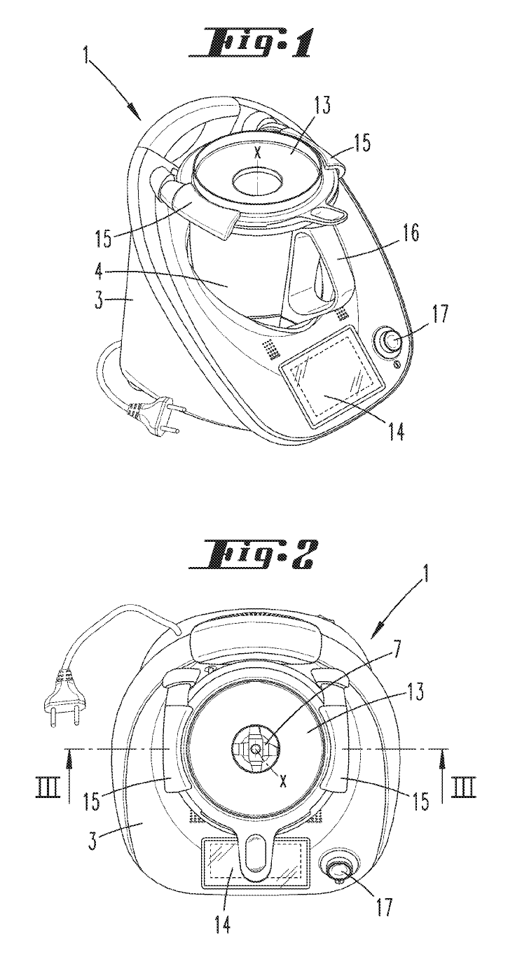

FIG. 1 shows an electric motor-driven food processor 1, which is realized in the form of a combined cooking-mixing device in this case. The food processor 1 comprises a base device 3, into which a preparation vessel 4 is inserted. A stirring unit 7 (not illustrated in FIG. 1) is arranged in the preparation vessel 4 and makes it possible to chop, stir or otherwise prepare preparation material located in the preparation vessel 4. The stirring unit 7 can be driven by means of an electric motor 2 (not illustrated in FIG. 1) that is arranged in the base device 3 of the food processor 1. The stirring unit 7 rotates about a rotational axis x. To this end, the stirring unit 7 engages into a rotatable coupling device 8 (not illustrated in FIG. 1) that is connected to the electric motor 2.

Furthermore, a cover element 13 is assigned to the preparation vessel 4 and can be connected to the preparation vessel 4 in a fluid-tight manner with the aid of closing rollers 15. The preparation vessel 4 also comprises a handle 16 such that a user can take hold of the preparation vessel 4. The base device 3 furthermore comprises a display 14 for displaying status parameters of the food processor 1, recipe suggestions, current parameters of the preparation material located in the preparation vessel 4 and the like. A switch 17, which in this example is realized in the form of a rotary/push-button, serves for switching the food processor 1 on and off and/or for selecting and confirming a command or parameter displayed on the display 14.

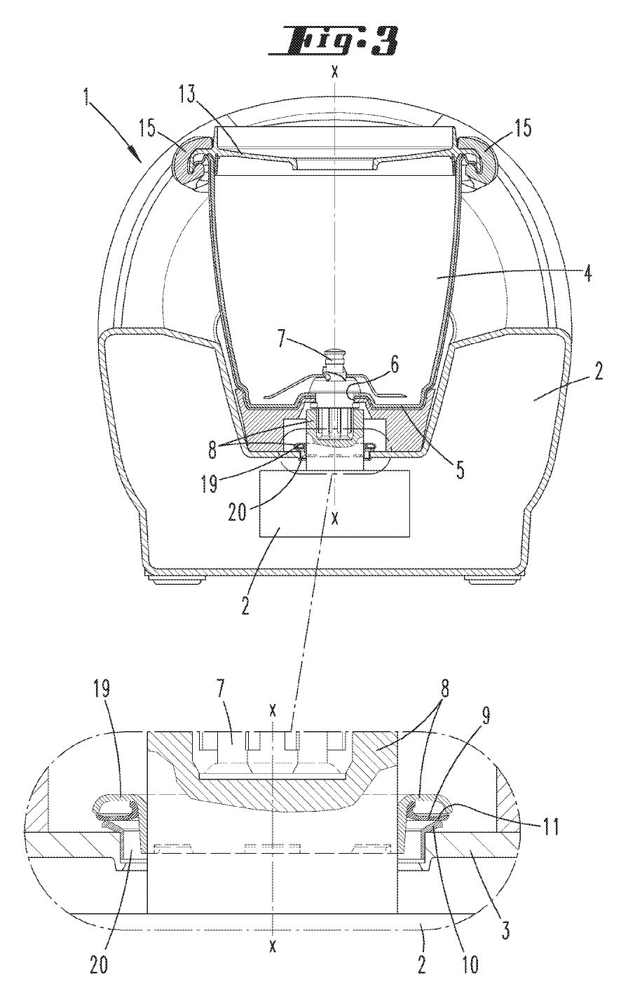

FIG. 2 shows the food processor 1 in the form of a top view. This illustration shows the stirring unit 7, which is realized in the form of a blade set and rotates about the rotational axis x of the coupling device 8.

FIG. 3 shows the food processor 1 in the form of a longitudinal section. The preparation vessel 4 has a vessel bottom 5 with a bottom opening 6, through which a partial region of the stirring unit 7 is guided and inserted into the coupling device 8 of the base device 3. The stirring unit 7 forms a closing element for the bottom opening 6 such that the bottom opening 6 is closed in a fluid-tight manner. The coupling device 8 and therefore also the stirring unit 7 rotate about the rotational axis x. The coupling device 8 is driven by means of the electric motor 2 such that the coupling device 8 rotates about the rotational axis x and in the process carries along the inserted stirring unit 7. In the partial region of the base device 3 of the food processor 1, which is illustrated in an enlarged manner in the figure, a free space 20 is formed between the rotating coupling device 8 and the stationary partial housing region 10 of the base device 3. The coupling device 8 comprises a collar 19 that points radially outward referred to the rotational axis x, wherein a sealing element 9 is arranged underneath said collar.

The collar 19 of the coupling device 8 is advantageously realized in one piece with the other partial regions of the coupling device 8, but may also be glued thereon or otherwise connected thereto. Referred to the longitudinal section shown, the collar 19 has an inverted L-shape or U-shape such that preparation material, which accidentally escapes from the preparation vessel 4 into the region of the collar 19, already drips off the collar 19 and cannot advance further into the base device 3 of the food processor 1. A sealing element 9 is arranged on the coupling device 8, in this case underneath the collar 19, and realized in the form of a flexible sealing lip. The sealing lip is made of a flexible, heat-resistant plastic, namely, of silicone rubber. In the non-rotating state of the coupling device 8 illustrated in FIG. 3, the sealing element 9 rests on a running surface 11 of a corresponding partial housing region 10 of the base device 3. A free space 20, which extends around the coupling device 8 in a ring-shaped manner, is formed between the corresponding partial housing region 10 and the coupling device 8. The free space 20 ensures that the rotating coupling device 8 does not drag along the partial housing region 10 and causes damages or abrasion of the coupling device 8 or the partial housing region 10 at this location. In the non-rotating state of the coupling device 8, the sealing element 9 rests on the running surface 11 of the partial housing region 10 in a fluid-tight manner in order to close this free space 20, i.e. to prevent the admission of preparation material into the free space 20.

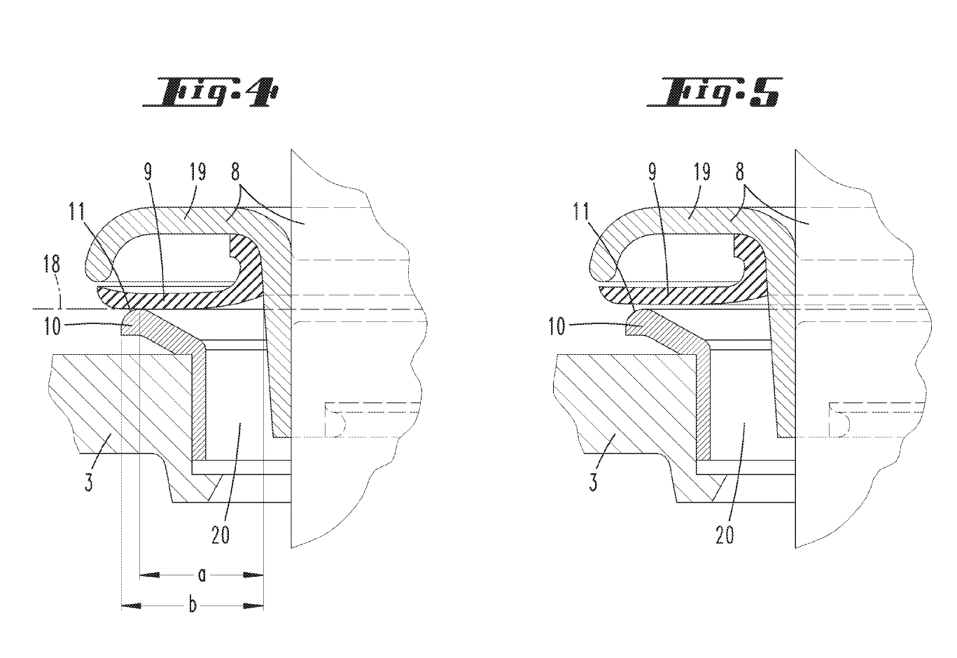

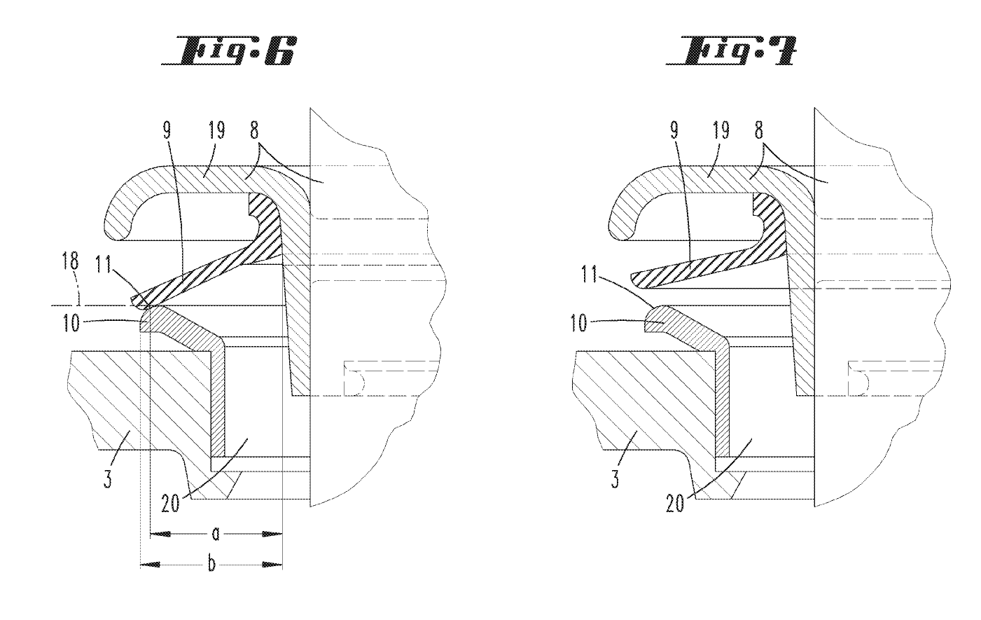

FIGS. 4 and 5 show the sealing element 9 arranged between the coupling device 8 and the partial housing region 10 in a position, in which the sealing element 9 rests on the running surface 11 of the partial housing region 10 (FIG. 4), and in a position, in which the sealing element is lifted off the running surface 11 (FIG. 5).

In the illustration according to FIG. 4, the coupling device 8 is not driven, i.e. in the non-rotating state. In this case, the sealing element 9 rests on the running surface 11 of the partial housing region 10 following gravity and produces a fluid-tight seal relative to the partial housing region 10 such that no preparation material can be admitted into the free space 20 and therefore into the base device 3. With respect to a radial direction (referred to the rotational axis x), the sealing element 9 is realized longer than a clearance a between the running surface 11 and the coupling device 8 in the same plane such that the sealing element 9 advantageously projects beyond the running surface 11 and produces an optimal seal relative to the running surface 11, namely also if preparation material lies on top of the sealing element 9. In a contact plane 18 that extends perpendicular to the rotational axis x, the clearance a between the contact point of the running surface 11 with the sealing element 9 and the intersecting point of the contact plane 18 with the coupling device 8 is smaller than the vertically projected length b of the sealing element 9 in the contact plane 18. According to the figure, it is not necessary to realize the sealing element 9 in a completely plane manner in this case. In fact, the sealing element may also have a curvature in order to produce an optimal seal with the running surface 11. In this context, it is particularly important that the sealing element 9 produces an optimal seal relative to the running surface 11, wherein this can also be promoted, in particular, with a curvature of the sealing element 9.

FIG. 5 shows the position of the sealing element 9 during a rotation of the coupling device 8. The sealing element 9 is stretched radially outward (referred to the rotational axis x) and thereby lifted off the running surface 11 of the partial housing region 10 due to the centrifugal force acting upon the sealing element 9 during the rotation of the coupling device 8. In this way, the sealing element 9 is transferred from the contacting sealing effect described above with reference to FIG. 4 to a non-contacting sealing effect (according to FIG. 5). The point in time, at which the sealing element 9 lifts off the running surface 11, is among other things defined by the rotational speed of the rotating coupling device 8, the mass of the sealing element 9, as well as the spatial arrangement and configuration of the sealing element 9 relative to the spatial arrangement and configuration of the corresponding running surface 11 of the partial housing region 10. The aforementioned parameters define a rotational speed limit, starting at which the sealing element 9 lifts off the running surface 11. During a rotation of the coupling device 8 or the sealing element 9 at the rotational speed limit, the centrifugal force acting upon the sealing element 9 and the gravitational force acting upon the sealing element 9 cancel out one another. At a rotational speed above the rotational speed limit, the acting centrifugal force is greater than the acting gravitational force such that the sealing element 9 is stretched and lifted off the corresponding running surface 11. As soon as the rotational speed once again drops below the rotational speed limit, the gravitational force acting upon the sealing element 9 outweighs the centrifugal force such that the sealing element 9 drops following gravity and contacts the running surface 11 of the partial housing region 10 in a fluid-tight manner. The opening of the free space 20 is therefore once again sealed in a fluid-tight manner. In this example, the rotational speed limit lies at 100 rpm such that the sealing element 9 not only has a contacting sealing function when the coupling device 8 is at a standstill, but also during a rotation of the coupling device 8 below 100 rpm, which corresponds, for example, to a typical rotational speed for a stirring function of the stirring unit 7. At this rotational speed, the sealing element 9 contacts the running surface 11 of the partial housing region 10 and seals the free space 20.

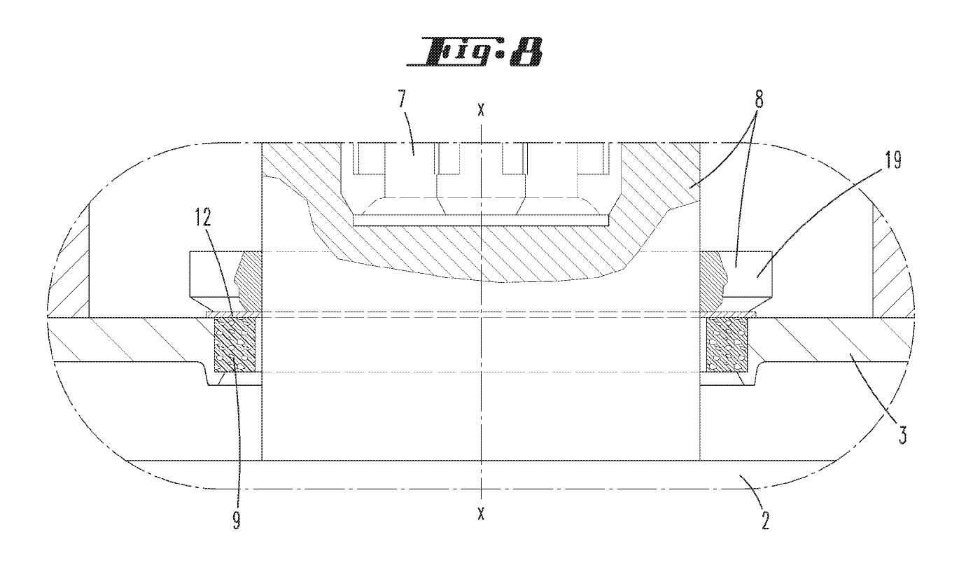

FIGS. 6 and 7 show another exemplary embodiment with a sealing element 9 during its fluid-tight contact with the running surface 11 (FIG. 6) and in a position, in which the sealing element is lifted off the running surface 11 (FIG. 7). In this embodiment, the sealing element 9 is not essentially arranged horizontally in the position, in which it rests on the running surface 11, but rather obliquely, in this case at an angle, e.g., of about 45° relative to the contact plane 18 and also to the rotational axis x. In this way, the free end region of the sealing element 9 not only produces a seal relative to the running surface 11 in an axial direction, but rather also in a radial direction, such that the sealing effect is additionally enhanced. In contrast to FIG. 4, the sealing element 9 already is essentially stretched in the idle position. In the embodiment according to FIGS. 6 and 7, the point in time, at which the sealing element 9 lifts off the running surface 11, is also dependent on the equilibrium between the centrifugal force acting upon the sealing element 9 and the gravitational force acting upon the sealing element 9. Starting at a rotational speed limit that is dependent on the mass of the sealing element 9, the sealing element 9 lifts off the running surface 11 such that the sealing element 9 is transferred from a state, in which it is in contact with the running surface 11, into a lifted-off state.

FIG. 8 shows an alternative embodiment of the invention, in which the sealing element 9 always seals in a contacting manner independently of the rotational speed of the coupling device 8. In this case, the sealing element 9 is realized in the form of a foam body that is arranged on the base device 3 and has a certain flexibility and elasticity. The sealing element 9 is realized in the form of a ring-shaped body. A corresponding collar 19 of the coupling device 8, which is likewise realized in a ring-shaped manner, rests on the sealing element 9. The side of the sealing element 9 that faces the coupling device 8 is provided with a surface layer 12, in this case a Teflon film that is glued on the sealing element 9. The collar 19 of the coupling device 8 is always in contact with the surface layer 12 of the sealing element 9 independently of the rotational speed. The sealing element 9 presses the surface layer 12 against the coupling device 8 due to the flexibility and elastic properties of the sealing element 9 such that an axial tolerance compensation is created and an optimal sealing effect is achieved. Furthermore, the surface layer 12 has a radial overlap with the collar 19 of the coupling device 8 in the radial direction referred to the rotational axis x such that a radial play of the coupling device 8 relative to the sealing element 9 can be compensated. Due to the heat resistance of the surface layer 12, the sealing effect of the sealing element 9 is also ensured at high rotational speeds of the coupling device 8, e.g. at rotational speeds in excess of 10,000 rpm.

Although not illustrated in FIG. 8, the side of the coupling device 8 acting against the sealing element 9 may have a convex running surface or the side of the sealing element 9 acting against the coupling device 8 may alternatively have a convex running surface, which additionally enhances the sealing effect between the sealing element 9 and the collar 19 of the coupling device 8. In this case, the running surface does not have to be realized in a convex manner over its entire radial width, but rather only along a ring-shaped strip of the running surface, e.g. in the form of a projection pointing in the direction of the corresponding opposite surface.

### LIST OF REFERENCE SYMBOLS

1 Food processor
2 Electric motor
3 Base device
4 Preparation vessel
5 Vessel bottom
6 Bottom opening
7 Stirring unit
8 Coupling device
9 Sealing element
10 Partial housing region
11 Running surface
12 Surface layer
13 Cover element
14 Display
15 Closing roller
16 Handle
17 Switch
18 Contact plane
19 Collar
20 Free space
a Clearance
b Length
x Rotational axis

1: An electric motor-driven food processor (1) with a base device (3) that has an electric motor (2) and with a preparation vessel (4) that can be inserted into the base device (3), wherein a vessel bottom (5) of the preparation vessel (4) has a bottom opening (6) that can be closed in a fluid-tight manner by means of a stirring unit (7), and wherein said stirring unit (7) can be engaged into a coupling device (8), which can be rotated by means of the electric motor (2), through the bottom opening (6), wherein the coupling device (8) comprises a sealing element (9), which is connected to the coupling device (8) in a rotationally fixed manner and designed for acting against a corresponding immovable partial housing region (10) of the base device (3) in a fluid-tight manner, particularly following gravity, at a rotational speed of the coupling device (8) below a defined rotational speed limit, as well as for releasing the functional connection due to a rotational speed-dependent centrifugal force effect at a rotational speed above the rotational speed limit.

2: The electric motor-driven food processor (1) according to claim 1, wherein the rotational speed limit lies between 50 rpm and 200 rpm.

3: The electric motor-driven food processor (1) according to claim 1, wherein the sealing element (9) is a flexible sealing lip, which surrounds the coupling device (8) in the circumferential direction.

4: The electric motor-driven food processor (1) according to claim 1, wherein the sealing element (9) is glued and/or clamped on the coupling device (8).

5: The electric motor-driven food processor (1) according to claim 1, wherein the sealing element (9) comprises a material with a heat resistance to temperatures greater than 100° C., particularly a heat resistance to temperatures greater than 150° C., preferably PTFE, silicone rubber, ethylene-propylene terpolymer (APTK), viton, butyl or Teflon.

6: The electric motor-driven food processor (1) according to claim 1, wherein the sealing element (9) has a material thickness of 0.5 mm to 2 mm.

7: The electric motor-driven food processor (1) according to claim 1, wherein the partial housing region (10) of the base device (3), which corresponds to the sealing element (9), has a convex running surface (11) for the sealing element (9).

8: The electric motor-driven food processor (1) according to claim 1, wherein a radial clearance (a) between the coupling device (8) and the corresponding partial housing region (10) of the base device (3) in a contact plane (18) of the partial housing region (10) and the sealing element (9) perpendicular to a rotational axis (x) of the coupling device (8) lies between 2 mm and 10 mm and/or wherein a radial length (b) of the sealing element (9) referred to a vertical projection of the sealing element (9) contacting the partial housing region (10) lies between 4 mm and 12 mm.

9: An electric motor-driven food processor (1) with a base device (3) that has an electric motor (2) and with a preparation vessel (4) that can be inserted into the base device (3), wherein a vessel bottom (5) of the preparation vessel (4) has a bottom opening (6) that can be closed in a fluid-tight manner by means of a stirring unit (7), and wherein said stirring unit (7) can be engaged into a coupling device (8), which can be rotated by means of the electric motor (2), through the bottom opening (6), wherein an immovable partial housing region (10) of the base device (3) lying adjacent to the coupling device (8) comprises a flexible sealing element (9), particularly a foam body, which is provided with a fluid-tight surface layer (12), particularly a Teflon film, on the side acting against the coupling device (8).

10: The electric motor-driven food processor (1) according to claim 9, wherein the coupling device (8) comprises a convex running surface for the sealing element (9), particularly a projection pointing in the axial direction, on the side acting against the sealing element (9) and/or wherein the sealing element (9) comprises a convex running surface for the coupling device (8), particularly a projection pointing in the axial direction, on the side acting against the coupling device (8).
